(19) United States
(12) Patent Application Publication
(10) Pub. No.: US 2026/0282103 A1
(43) Pub. Date: Sep. 17, 2026

(54) RO Indexing for Multiple PRACH Transmissions

(71) Applicant: Telefonaktiebolaget LM Ericsson (publ), Stockholm (SE)

(72) Inventors: Ling Su, Beijing (CN); Oskar Myrberg, Norrköping (SE)

(21) Appl. No.: 19/472,470

(22) PCT Filed: Mar. 21, 2024
(86) PCT No.: PCT/SE2024/050256

§ 371 Date: Oct. 3, 2025

(30) Foreign Application Priority Data
Apr. 6, 2023 (WO) PCT/CN2023/086674

(51) Int. Cl. H04W 74/0833; H04W 72/30

(52) U.S. Cl. CPC H04W 74/0833; H04W 72/30

(57) ABSTRACT

The present disclosure is related to terminal nodes, network nodes, and methods for RO indexing to ensure the alignment of ROs, so that the network nodes can combine them for a PRACH attempt. A method at a terminal node is provided, including: determining a number of PRACH transmissions; determining a configured number K of PRACH transmissions; determining a number R of ROs associated with a selected SSB and with a preamble partition applicable to the determined number of PRACH transmissions within one association period; determining an extended association period, including a number X of association periods; determining, within the extended association period, a set of ROs for indexing; indexing the determined ROs in the set of ROs; and performing one or more PRACH transmissions based on the determined number of PRACH transmissions in the set of indexed ROs.

### TECHNICAL FIELD

The present disclosure is related to the field of telecommunication, and, in particular, to terminal nodes, network nodes, and methods for Physical Random Access Channel (PRACH) Occasion (RO) indexing in multiple PRACH transmissions.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly power-efficient Radio Access Network (RAN), such as a fifth generation (5G) New Radio (NR) RAN, will be required.

### NR Cell Search and System Information Acquisition

In NR, the combination of synchronization signals (SS) and physical broadcast channel (PBCH) is referred to as a SS/PBCH block (SSB). Similar to LTE, a pair of SS, primary synchronization signal (PSS) and secondary synchronization signal (SSS), is periodically transmitted on downlink from each cell to allow a UE to initially access to the network. By detecting SS, a UE can obtain the physical cell identity, achieve downlink synchronization in both time and frequency, and acquire the timing for PBCH. PBCH carries the master information block (MIB), which contains a minimum system information that a UE is needed to acquire system information block 1 (SIB 1). SIB1 carries the remaining minimum system information that is needed for a UE to be able to perform subsequent random-access procedure.

Up to 4, 8, 64 SSBs, depending on the frequency range of the frequency band used, can be transmitted in one SSB period which can be 5 ms, 10 ms, 20 ms, 40 ms, 80 ms or 160 ms configured in SIB1, the default SSB period is 20 ms assumed for initial cell search since SIB1 is not available.

### NR Random Access Procedure

Random access is performed by a terminal device, e.g., User Equipment (UE), in NR and Long Term Evolution (LTE) networks for accessing to a new cell. Once a random access procedure is completed, a terminal device can be connected to a network device, e.g., evolved NodeB (eNB) or gNB, and communicate with the network device using dedicated transmissions.

Two types of random access procedure are supported: 4-step random access type with Msg1 and 2-step random access type with MSGA. Both types of Random Access (RA) procedure support contention-based random access (CBRA) and contention-free random access (CFRA).

FIG. 1A shows a signaling sequence of a 4-step contention based random access procedure, also referred to as Type-1 random access procedure in 3GPP TS 38.213. As shown, at 101, a UE detects a Synchronization Signal (SS) from a gNB. At 102, the UE decodes Master Information Block (MIB) and System Information Block (SIB) (i.e., Remaining Minimum System Information (RMSI) and Other System Information (OSI), which may be distributed over multiple physical channels such as Physical Broadcast Channel (PBCH) and Physical Downlink Shared Channel (PDSCH), to acquire random access transmission parameters. At 111, where the UE transmits a Physical Random Access Channel (PRACH) preamble, or Msg1, to the gNB. The gNB detects the Msg1 and responds with a Random Access Response (RAR), or Msg2, at 112. At 113, the UE transmits a Physical Uplink Shared Channel (PUSCH), or Msg3, to the gNB in accordance with configuration information for PUSCH transmission carried in the RAR. At 114, the gNB transmits a Contention Resolution Message, or Msg4, to the UE.

In the 4-step random access procedure as shown in FIG. 1A, the resource, including time resource and frequency resource, for PUSCH (i.e., Msg3) is indicated in the RAR (i.e., Msg2). In particular, the RAR contains an uplink grant including a 14-bit “PUSCH frequency resource allocation” field indicating the frequency domain resource for PUSCH and a 4-bit “PUSCH time resource allocation” field indicating the time domain resource for PUSCH.

There can be cases that multiple UEs select the same random-access preamble and transmit the preamble on the same PRACH time/frequency resource. This preamble collision is called contention. One of the main purposes of applying Step 113 and Step 114 is to resolve such potential contention.

In order to minimize the number of channel accesses, which is important for e.g. operations in unlicensed frequency bands where Listen Before Talk (LBT) is required before transmission, a 2-step random access procedure has also been proposed for NR. Instead of using the four steps 111-114, the 4-step random access procedure completes random access in only two steps with two messages, which may be referred to as Msg A and Msg B. FIG. 1B shows a signaling sequence of a 2-step contention based random access procedure, also referred to as Type-2 random access procedure in TS 38.213. As shown, the steps 101-102 in FIG. 1B are the same as the steps 101-102 in FIG. 1A. At 121, the UE transmits a PRACH preamble and a PUSCH in one message (i.e., Message A, msgA) to the gNB. The PUSCH may include higher layer data such as Radio Resource Control (RRC) connection request, possibly with some small additional payload. At 122, the gNB transmits Message B (msgB) to the UE, including UE identifier assignment, timing advance information and contention resolution message (CRM), etc.

FIG. 2A illustrates a 4-step random access type contention free random access, and FIG. 2B illustrates a 2-step random access type contention free random access. As shown in FIG. 2A, the network node 104 assigns a preamble for CFRA in 4-step RACH, and, as shown in FIG. 2B, the network node 104 assigns a preamble and PUSCH for CFRA in 2-step RACH. The network node 104 does not configure CFRA resources for 4-step and 2-step RA types at the same time for a Bandwidth Part (BWP). CFRA with 2-step RA type is only supported for handover.

The Msg1 of 4-step RA type includes only a preamble on PRACH, while the MSGA of the 2-step RA type includes a preamble on PRACH and a payload on PUSCH. After Msg1 transmission or MSGA transmission, the UE 102 monitors for a response from the network node 104 within a configured window. For CFRA, upon receiving the network response, the UE 102 ends the random access procedure.

### PRACH Configuration

In NR, the time and frequency resource on which a RACH preamble is transmitted is defined as a PRACH Occasion, RO.

The time resources and the preamble format for a PRACH preamble is configured by an RACH configuration index. For details of the PRACH configuration index, reference can be made to the 3GPP TS38.211, which is incorporated herein by reference in its entirety. The PRACH configuration index indicates a row in a PRACH configuration table specified in TS 38.21, Tables 6.3.3.2-2, 6.3.3.2-3, 6.3.3.2-4 for FR1 (for example, 450 MHz-6 GHz) paired spectrum, FR1 unpaired spectrum and FR2 (for example, 24.25 GHz-52.6 GHz) with unpaired spectrum, respectively, a row in a RACH configuration table specifies the time-domain PRACH occasion pattern for one RACH configuration period. One PRACH configuration period may be 10, 20, 40, 80, or 160 ms.

In the frequency domain, NR supports multiple frequency-multiplexed RACH occasions on the same time-domain RACH occasion. This is mainly motivated by the support of analog beam sweeping in NR such that the RACH occasions associated to one SSB are configured at the same time instance but different frequency locations. PRACH preambles can only be transmitted in the frequency resources given by the higher-layer parameter msg1-FrequencyStart. The frequency resource for PRACH occasions n_{RA}∈{0,1, . . . ,M−1}, where M equals the higher-layer parameter msg1-FDM, is numbered in increasing order within the initial active uplink bandwidth part during initial access, starting from the lowest frequency. Otherwise, n_{RA} is numbered in increasing order within the active uplink bandwidth part, starting from the lowest frequency. The number M of PRACH occasions that are frequency domain multiplexed (FDMed) in one time-domain RACH occasion, can be 1, 2, 4, or 8.

FIG. 3 illustrates an example of the PRACH Occasion configuration in NR. As shown in FIG. 3, four PRACH occasions are frequency division multiplexed in one time instance.

In NR Rel-17, there are up to 64 sequences that can be used as RACH preambles per RACH occasion in each cell. The RRC parameter totalNumberOfRA-Preambles determines how many of these 64 sequences are used as RACH preambles per RACH occasion in each cell. The 64 sequences are configured by including firstly all the available cyclic shifts of a root Zadoff-Chu sequence, and secondly in the order of increasing root index, until 64 preambles have been generated for the RACH occasion.

### NR Rel-17 Association Between SSB and PRACH Occasion

NR Rel-17 supports one-to-one, one-to-many, and many-to-one association between SSB and RACH Occasions.

The RACH preambles associated to each SSB is configured by two RRC parameters in RACH-ConfigCommon: ssb-perRACH-OccasionAndCB-PreamblesPerSSB and totalNumberOfRA-Preambles.

FIG. 4 illustrates an example of the mapping between SSB and RACH preambles, where the number of SSBs is 8, M=32 (i.e., 2 SSB per PRACH occassions), the number of PRACH occasions that are frequency division multiplexed in one time instance is 2. The PRACH format is A3, i.e., 2 TD PRACH occasions per slot. The PRACH configuration period is 20 ms, and there are 2 PRACH slots per configuration period.

For each SSB, the associated preambles per PRACH occasion,

$${N}_{preamble}^{total} / N ,$$

are further divided into two sets for Contention Based Random Access (CBRA) and Contention Free Random Access (CFRA). The number of CB preambles per SSB per PRACH occasion, R, is signaled by the RRC parameter ssb-perRACH-OccasionAndCB-PreamblesPerSSB. Preamble indices for CBRA and CFRA are mapped consecutively for one SSB in one PRACH occasion.

In 3GPP Rel-18, multiple PRACH transmissions are supported, in which a UE transmits multiple PRACHs in a set of ROs for a PRACH attempt. The UE and gNB need to be aligned on the set of specific ROs in order for gNB to combine them for a PRACH attempt and for UE and gNB to determine the start of RAR window, Random Access-Radio Network Temporary Identity (RA-RNTI), etc.

However, on one hand, in NR up to Rel-18, RO indexing is only specified for CFRA, and there is no specification on RO indexing for CBRA. On the other hand, the RO indexing for CFRA is specified for three scenarios and will cause some problems or restrictions if applied to UE determination of a set of ROs for multiple PRACH transmissions.

Moreover, there may be problems when there are time-domain overlapping ROs between legacy ROs and separate ROs.

### SUMMARY

An object of the present application is to provide some solutions of RO indexing for multiple PRACH transmissions, and solutions for addressing the problems when there are time-domain overlapping ROs between legacy ROs and separate ROs.

According to a first aspect of the present disclosure, a method at a terminal node for performing multiple Physical Random Access Channel, PRACH, transmissions for a PRACH attempt is provided. The method includes: determining a number of PRACH transmissions based on a parameter received from a network node; determining a configured number K of PRACH transmissions; determining a number R of PRACH Occasions, ROs, associated with a selected SSB and with a preamble partition applicable to the determined number of PRACH transmissions within one association period; determining an extended association period, the extended association period including a number X of association periods, where the number X of association periods is the minimum number of association periods such that X·R≥K; determining, within the extended association period, a set of ROs for indexing, where an RO in the set of ROs is associated with the selected SSB and with a preamble partition applicable to the determined number of PRACH transmissions; indexing the determined ROs in the set of ROs; and performing one or more PRACH transmissions based on the determined number of PRACH transmissions in the set of indexed ROs, wherein the number of ROs in the set is equal to the determined number of PRACH transmissions.

According to a second aspect of the present disclosure, a terminal node is provided. The terminal node is configured to: determine a number of PRACH transmissions based on a parameter received from a network node; determine a configured number K of PRACH transmissions; determine a number R of PRACH Occasions, ROs, associated with a selected SSB and with a preamble partition applicable to the determined number of PRACH transmissions within one association period; determine an extended association period, the extended association period including a number X of association periods, where the number X of association periods is the minimum number of association periods such that X·R≥K; determine, within the extended association period, a set of ROs for indexing, where an RO in the set of ROs is associated with the selected SSB and with a preamble partition applicable to the determined number of PRACH transmissions; index the determined ROs in the set of ROs; and perform one or more PRACH transmissions based on the determined number of PRACH transmissions in the set of indexed ROs, wherein the number of ROs in the set is equal to the determined number of PRACH transmissions.

According to a third aspect of the present disclosure, a method at a network node for receiving multiple PRACH transmissions for a PRACH attempt from a terminal node is provided. The method includes: determining a number of PRACH transmissions; determining a configured number K of PRACH transmissions; determining a number R of PRACH Occasions, ROs, associated with a selected SSB and with a preamble partition applicable to the determined number of PRACH transmissions within one association period; determining an extended association period, the extended association period including a number X of association periods, where the number X of association periods is the minimum number of association periods such that X·R≥K; determining, within the extended association period, a set of ROs for indexing, where an RO in the set of ROs is associated with the selected SSB and with a preamble partition applicable to the determined number of PRACH transmissions; indexing the determined ROs in the set of ROs; and receiving and associating the number of PRACH transmissions in the set of indexed ROs with a PRACH attempt, wherein the number of ROs in the set is equal to the determined number of PRACH transmissions.

According to a fourth aspect of the present disclosure, a network node is provided. The network node is configured to: determine a number of PRACH transmissions; determine a configured number K of PRACH transmissions; determine a number R of PRACH Occasions, ROs, associated with the selected SSB and with a preamble partition applicable to the determined number of PRACH transmissions within one association period; determine an extended association period, the extended association period including a number X of association periods, where the number X of association periods is the minimum number of association periods such that X·R≥K; determine, within the extended association period, a set of ROs for indexing, where an RO in the set of ROs is associated with the selected SSB and with a preamble partition applicable to the determined number of PRACH transmissions; index the determined ROs in the set of ROs; and receive and associate the number of PRACH transmissions in the set of indexed ROs with a PRACH attempt, wherein the number of ROs in the set is equal to the determined number of PRACH transmissions.

The present disclosure proposes a solution of RO indexing for multiple PRACH transmissions to assist the UE and gNB to align on the set of ROs, so that the gNB can combine them for a PRACH attempt. The present disclosure also proposes a solution for PRACH transmission in case there is time-domain overlapping RO between two PRACH configuration.

### BRIEF DESCRIPTION OF THE DRAWINGS

FIG. 1A shows a signaling sequence of a 4-step contention based random access procedure.

FIG. 1B shows a signaling sequence of a 2-step contention based random access procedure.

FIG. 2A illustrates a 4-step random access type contention free random access.

FIG. 2B illustrates a 2-step random access type contention free random access.

FIG. 3 illustrates an example of the RACH Occasion configuration in NR.

FIG. 4 illustrates an example of the mapping between SSB and RACH preambles.

FIG. 5 is a diagram illustrating an exemplary telecommunications network in which UEs and gNB may be operated according to an embodiment of the present disclosure.

FIG. 6 illustrates a PRACH configuration index in FR2 TDD.

FIG. 7 is a flow chart illustrating an exemplary method at a terminal node for performing multiple PRACH transmissions for a PRACH attempt according to an embodiment of the present disclosure.

FIG. 8 is a flow chart illustrating an exemplary method at a network node for receiving multiple PRACH transmissions for a PRACH attempt from a terminal node according to an embodiment of the present disclosure.

FIG. 9 illustrates results of distributing PRACH transmissions over ROs according to an embodiment of the present disclosure.

FIG. 10 illustrate a scenario where there are time domain overlapping ROs between two PRACH configurations.

FIG. 11 is a flow chart illustrating an exemplary method at a terminal node for performing PRACH transmission for a PRACH attempt according to an embodiment of the present disclosure.

FIG. 12 illustrates results of applying the embodiments of the present application.

FIG. 13 schematically shows an embodiment of an arrangement which may be used in a terminal node or a network node according to an embodiment of the present disclosure.

FIG. 14 is a block diagram of an exemplary terminal node according to an embodiment of the present disclosure.

FIG. 15 is a block diagram of an exemplary network node according to an embodiment of the present disclosure.

FIG. 16 is a block diagram of an exemplary terminal node according to an embodiment of the present disclosure.

FIG. 17 shows an example of a communication system 1700 in accordance with some embodiments.

FIG. 18 shows a UE in accordance with some embodiments.

FIG. 19 shows a UE in accordance with some embodiments.

FIG. 20 is a block diagram of a host 2000, which may be an embodiment of the host 1716 of FIG. 17, in accordance with various aspects described herein.

FIG. 21 is a block diagram illustrating a virtualization environment 2100 in which functions implemented by some embodiments may be virtualized.

FIG. 22 shows a communication diagram of a host 2202 communicating via a network node 2204 with a UE 2206 over a partially wireless connection in accordance with some embodiments.

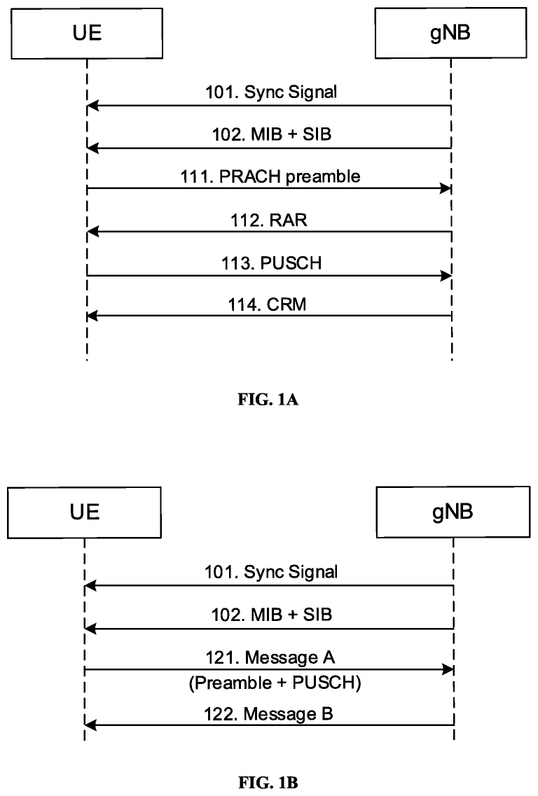

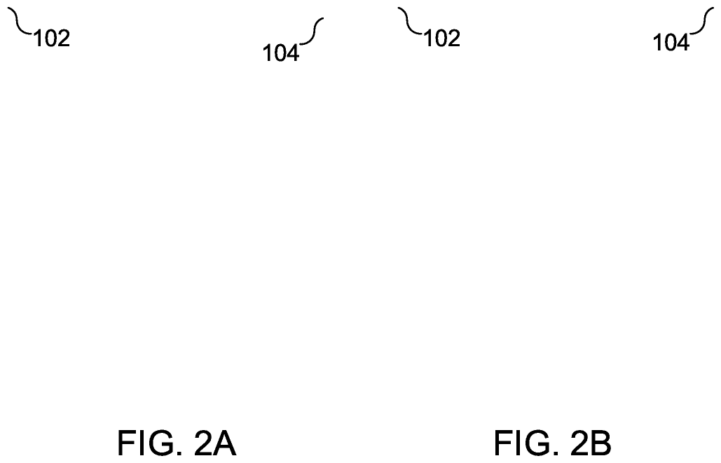

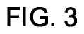

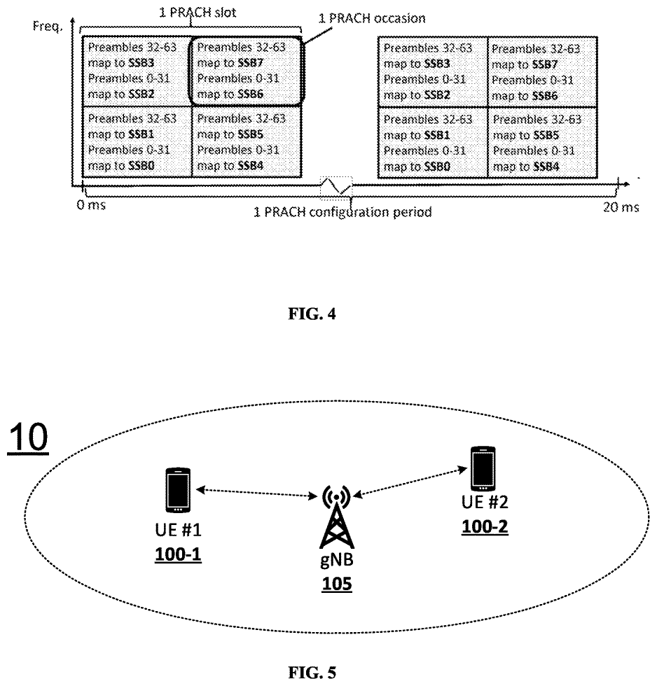

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows:
1) 3GPP TS 38.213 V17.5.0 (2023-03),
2) 3GPP TS 38.321 V17.4.0 (2023-03),
3) 3GPP TS 38.211 V17.4.0 (2022-12), and
4) 3GPP TS 38.331 V17.4.0 (2023-03).

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the skilled in the art to affect such feature, structure, or characteristic in connection with other embodiments whether or not explicitly described.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some exemplary embodiments be embodied in one or more application-specific integrated circuits (ASICs). In some exemplary embodiments, these processing circuits may comprise one or more microprocessors, microcontrollers, and/or digital signal processors programmed with appropriate software and/or firmware to carry out one or more of the operations described above, or variants thereof. In some exemplary embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

In the following description and claims, unless defined otherwise, all technical and scientific terms used herein have the same meaning as commonly understood by one of ordinary skills in the art to which this disclosure belongs.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier-Frequency Division Multiple Access (SC-FDMA), Long Term Evolution (LTE), New Radio (NR) and other networks developed in the future. The terms “network” and “system” are sometimes used interchangeably. For illustration only, certain aspects of the techniques are described below for the 5^{th} generation of wireless communication network. However, it will be appreciated by the skilled in the art that the techniques described herein may also be used for other wireless networks such as LTE and corresponding radio technologies mentioned herein as well as wireless networks and radio technologies proposed in the future.

One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device.

As used herein, the term “UE” may be, by way of example and not limitation, a User Equipment (UE), a SS (Subscriber Station), a Portable Subscriber Station (PSS), a Mobile Station (MS), a Mobile Terminal (MT) or an Access Terminal (AT). The UE may include, but not limited to, mobile phones, cellular phones, smart phones, or personal digital assistants (PDAs), portable computers, image capture terminal devices such as digital cameras, gaming terminal devices, music storage and playback appliances, wearable terminal devices, vehicle-mounted wireless terminal devices and the like. In the following description, the terms “UE”, “wireless communication device,” “terminal device,” “mobile terminal” and “user equipment” may be used interchangeably.

As used herein, a “network node” is any node that is either part of the radio access network or the core network of a cellular communications network/system.

FIG. 5 is a diagram illustrating an exemplary telecommunications network 10 in which UE #1 100-1, UE #2 100-2, and gNB 105 may be operated according to an embodiment of the present disclosure. Although the telecommunications network 10 is a network defined in the context of 5G NR, the present disclosure is not limited thereto.

As shown in FIG. 5, the network 10 may comprise one or more UEs 100-1 and 100-2 (collectively, UE(s) 100) and a RAN node 105, which could be a base station, a Node B, an evolved NodeB (eNB), a gNB, or an AN node which provides the UEs 100 with access to the network. Further, the network 10 may comprise its core network portion that is not shown in FIG. 5.

However, the present disclosure is not limited thereto. In some other embodiments, the network 10 may comprise additional nodes, less nodes, or some variants of the existing nodes shown in FIG. 5. For example, in a network with the 4G architecture, the entities (e.g., an eNB) which perform these functions may be different from those (e.g., the gNB 105) shown in FIG. 5. For another example, in a network with a mixed 4G/5G architecture, some of the entities may be same as those shown in FIG. 5, and others may be different.

Further, although two UEs 100 and one gNB 105 are shown in FIG. 5, the present disclosure is not limited thereto. In some other embodiments, any number of UEs and/or any number of gNBs may be comprised in the network 10.

As shown in FIG. 5, the UEs 100 may be communicatively connected to the gNB 105 which in turn may be communicatively connected to a corresponding Core Network (CN) and then the Internet, such that the UEs 100 may finally communicate its user plane data with other devices outside the network 10, for example, via the gNB 105.

In 3GPP Rel-18, multiple PRACH transmissions are provided, where a UE transmits multiple PRACHs in a set of ROs (PRACH occasions) for a PRACH attempt. The UE and gNB need to be aligned on the set of specific ROs in order for gNB to combine them for a RACH attempt and for UE and gNB to determine the start of RAR window, RA-RNTI, etc. A simple solution of UE determination of a set of ROs is based on RO index. For an example of K PRACH transmissions, the index of the starting RO can be determined as mod(starting RO index, K)=0. It can be observed that RO indexing is needed to support UE determination of ROs for multiple PRACH transmissions. However, on one hand, in NR up to Rel-18, RO indexing is only specified for CFRA, and there is no specification on RO indexing for CBRA. On the other hand, the RO indexing for CFRA is specified for the following three scenarios and will cause some problems or restrictions if applied to UE determination of a set of ROs for multiple PRACH transmissions. Reasons and related clauses are as follows.
Scenario 1: RO indexing is limited within 1/N consecutive valid PRACH occasions per SSB, provided that a UE is provided a number N of SS/PBCH blocks associated with one PRACH occasion and N<1
Scenario 2: RO indexing for SI request is within an association period.
Scenario 3: If csirs-ResourceList is provided, RO indexing is reset per association pattern period.

Some related part in 3GPP TS38.213 v17.4.0 is cited here as following.

Some related part in 3GPP TS38.321 v17.2.0 is cited here as following.

Some related part in 3GPP TS38.331 v17.4.0 is cited here as following.

### SI-RequestConfig Information Element

-- ASN1START
-- TAG-SI-REQUESTCONFIG-START

| | |
|---|---|
| SI-RequestConfig ::= | SEQUENCE { |
| rach-OccasionsSI | SEQUENCE { |
| rach-ConfigSI | RACH-ConfigGeneric, |
| ssb-perRACH-Occasion | ENUMERATED {oneEighth, oneFourth, oneHalf, |
| one, two, four, eight, sixteen} | |
| } | OPTIONAL, -- Need R |
| si-RequestPeriod | ENUMERATED {one, two, four, six, eight, ten, twelve, |

sixteen} OPTIONAL, -- Need R

| | |
|---|---|
| si-RequestResources | SEQUENCE (SIZE (1..maxSI-Message)) OF SI- |
| RequestResources | |
| } | |
| SI-RequestResources ::= | SEQUENCE { |
| ra-PreambleStartIndex | INTEGER (0..63), |
| ra-AssociationPeriodIndex | INTEGER (0..15) |
| OPTIONAL, -- Need R | |
| ra-ssb-Occasion MaskIndex | INTEGER (0..15) |

OPTIONAL -- Need R
}
-- TAG-SI-REQUESTCONFIG-STOP
-- ASN1STOP

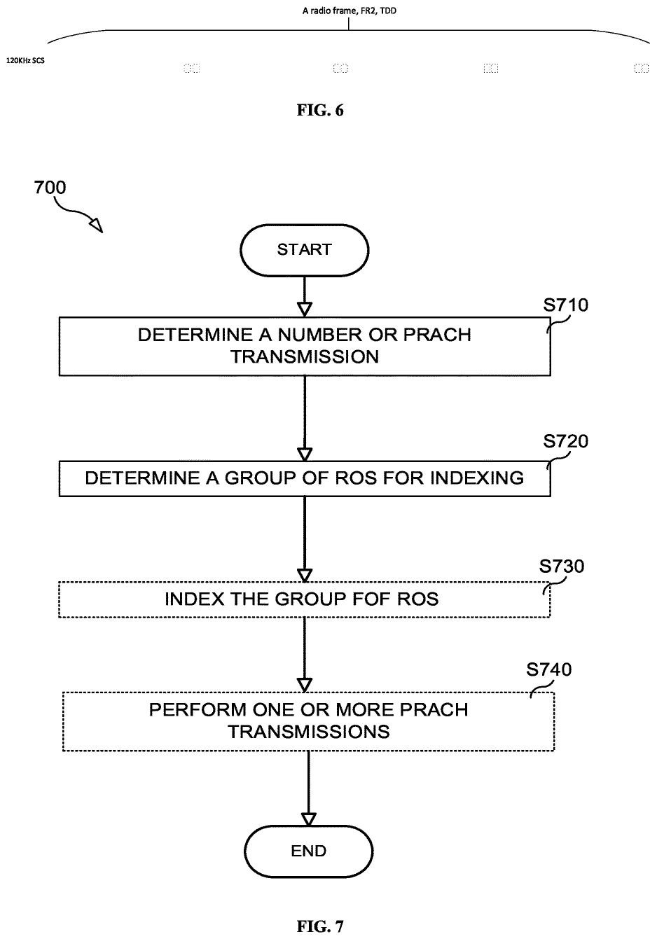

According to the definition in 3GPP TS38.213, an association period is the smallest time span among those supported for at least one SS/PBCH block indexes to PRACH occasions mapping cycle. For example, as shown in FIG. 6 for PRACH configuration index 127 in FR2 TDD, if SCS is 120 KHz, there are 8 ROs in a PRACH configuration period of 10 ms.

For Rel-18 multiple PRACH transmissions, it was agreed that “For multiple PRACH transmissions with same beam, at least ROs located at different time instances can be utilized for the transmissions.” In other words, multiple PRACH transmissions multiplexed in time domain are supported. For the sake of simplicity, if there are multiple FDMed ROs associated with one SSB, we only consider one of them at a time instance.

Let's make some assumptions for an example:
there are two SSBs, SSB1 and SSB2;
onehalf is provided by ssb-perRACH-OccasionAndCB-PreamblesPerSSB, indicating one SSB is associated with two ROs.

SSB to RO mapping is shown in Table 1. There are four ROs associated with an SSB in the association period, and among them two ROs are consecutive. According to CFRA RO indexing scenario 1, the RO index is up to two. The four ROs associated with an SSB have corresponding index of 0, 1, 0, 1, if the index starts from 0. Actually, if the four ROs have index of 0-3, they can be used for the first, second, third and fourth PRACH transmission of a RACH attempt. But with index of 0 and 1, it is unclear how to support the number of PRACH transmissions larger than 2.

Since the ROs in the PRACH configuration period are sufficient for at least one SSB-RO mapping cycle, the association period is 10 ms. For a selected SSB, e.g., SSB #1, one association period consists of two sets of ROs for two PRACH transmissions and one set of ROs for four PRACH transmissions, but it can't accommodate a set of ROs for eight transmissions, which otherwise can be supported by ROs in two association periods. In a summary, one observation is that it is beneficial that multiple PRACH transmissions of a RACH attempt can span multiple association periods, which exceeds the range of CFRA RO indexing scenario 2.

TABLE 1
SS/PBCH block indexes to PRACH occasions
mapping with two SSBs

| | | | | | | | | |
|---|---|---|---|---|---|---|---|---|
| RO index in a PRACH | 0 | 1 | 2 | 3 | 4 | 5 | 6 | 7 |
| configuration period | | | | | | | | |
| associated SSB index | 1 | 1 | 2 | 2 | 1 | 1 | 2 | 2 |

Lastly, if a set of ROs for multiple PRACH transmissions of a RACH attempt spans X association periods, in which the number of ROs associated with one SSB is sufficient for a number of PRACH transmissions, the value of X is determined based on the number of PRACH transmissions. Differently, the number of association periods in an association pattern period in scenario 3 is based on SSB periodicity. If the time span of X association periods is larger than an association patter period, the CFRA RO indexing method in scenario 3 will cause the same problem as mentioned above for scenario 1.

RO group was discussed in RAN1 #112 with an agreement, the related part is quoted below.

Working Assumption
For multiple PRACH transmissions with same
Tx beam, to differentiate the multiple PRACH
transmissions with single PRACH transmission,
at least support that multiple PRACH are
transmitted on separate ROs.
Note: Separate RO means that the RO is
separated with single PRACH transmission.
FFS: whether Rel-17 framework of feature
combination (FeatureCombination-r17) and
additional RACH configuration (AdditionalRACH-
Config-r17) can be reused for Rel-18 multiple
PRACH transmissions to realize the corresponding
PRACH resource partitioning.
Agreement
For multiple PRACH transmissions with same Tx
beam, “RO group” is assumed for multiple
PRACH transmissions with separate preamble
on shared ROs and/or multiple PRACH
transmissions on separate ROs, and one RO
group consists of valid RO(s) for a specific
number of multiple PRACH transmissions.
Note 1: All ROs in one RO group is associated
with the same SSB(s).
Note 2: Shared or separate RO/preamble means
that the RO/preamble is shared or separated
with single PRACH transmission.
Note 3: whether/how to define “RO group” in
specification will be discussed separately
Note 4: Valid RO(s) refers to what is defined
in existing specification
FFS: whether and how to address collision
between valid ROs for multiple PRACH
transmissions and other existing ROs for legacy
single PRACH transmission or other features,
e.g., 2-step RACH.
FFS: the time span of RO group.
FFS: whether and how ROs can be shared between
different RO groups for different number
of multiple PRACH transmissions.
FFS: other details

Since it is still open whether an RO group consists of ROs for multiple PRACH transmissions for only one RACH attempt or several RACH attempts, in this IvD, we use the term ‘a set of ROs’ to refer to ROs associated with an SSB for the multiple PRACH transmissions of one RACH attempt.

It was also agreed in RAN1 #112 that a gNB can configure more of {2, 4, 8} as the possible numbers of multiple PRACH transmissions. It is FFS how to differentiate PRACH resources among the different numbers. For example, a gNB can configure separate preamble partitions in an RO or separate ROs for different numbers of PRACH transmissions. Still other methods are not precluded yet, e.g., different numbers of PRACH transmissions are configured in one preamble partition.

Agreement
Support {2, 4, 8} for the number of multiple
PRACH transmissions with same Tx beams.
Agreement
For multiple PRACH transmissions with same
Tx beam, gNB can configure one or multiple
values for the number of multiple PRACH transmissions.
If multiple values are configured, PRACH
resources differentiation between multiple
PRACH transmissions with different number
of multiple PRACH transmissions is
supported.
FFS: details

Regardless of gNB configuration, a common sense is that a UE, which determines a specific number of PRACH transmissions, only transmits PRACH in ROs with a preamble partition applicable to its determined number. A general embodiment for RO counting and indexing is that a UE only counts ROs with a preamble partition applicable to its determined number of PRACH transmissions. In other words, ROs without preamble for the UE determined number of PRACH transmissions are not counted in for indexing.

If an association period does not have ROs associated with one SSB enough for a particular number of PRACH transmissions, which is configured by gNB, a UE which aims for this number of PRACH transmissions will look for ROs in at least several association periods for a RACH attempt. A minimum of X association periods provides ROs associated with the selected SSB, where the total number of such ROs is equal or larger than the number of PRACH transmissions of a RACH attempt. X≥1. For example, according to Table 1, a UE determines two association periods for 8 PRACH transmissions, one association period for 4 PRACH transmissions and one of the two sets of ROs in one association period for 2 PRACH transmissions. The same as an association period, the X association periods also starts from radio frame 0.

In the following, we provide a rule for RO counting and RO indexing and a method of determination of X and RO indexing. Based on these, a UE can determine a set of ROs for a RACH attempt.

FIG. 7 is a flow chart of an exemplary method 700 at a terminal node for performing multiple PRACH transmissions for a PRACH attempt according to an embodiment of the present disclosure. The method 700 may be performed at a terminal node (e.g., the UE 100). The method 700 may comprise step S710-S740. However, the present disclosure is not limited thereto. In some other embodiments, the method 700 may comprise more steps, less steps, different steps, or any combination thereof. Further the steps of the method 700 may be performed in a different order than that described herein. Further, in some exemplary embodiments, a step in the method 700 may be split into multiple sub-steps and performed by different entities, and/or multiple steps in the method 700 may be combined into a single step.

The method 700 may begin at step S710 where it determines a number of PRACH transmissions based on a parameter received from a network node. The network node may configure one or more candidate numbers for the number of PRACH transmissions. For example, the network node may configure {2, 4, 8} as the number of PRACH transmissions. The terminal node may determine one from the configured numbers by itself. For example, in CBRA case, the terminal node may determine the number of PRACH transmission by its SSB measurement.

At step S720, the terminal node determines a group of ROs for indexing, where an RO in the group of ROs being associated with a selected SSB and with a preamble partition applicable to the determined number of PRACH transmissions.

Then in step S730, the ROs in the group of ROs determined in step S720 are indexed.

Finally, in step S740, the terminal node performs one or more PRACH transmissions based on the determined number of PRACH transmissions in a set of indexed ROs, wherein a number of ROs in the set is equal to the determined number of PRACH transmissions. The terminal node firstly determines a group of ROs, i.e., candidate ROs for performing the PRACH transmissions, and then selects a set of ROs from the group for actually performing the PRACH transmissions.

In one embodiment, if the number of PRACH transmissions are multiplexed in time domain, and if there are multiple frequency multiplexing ROs associated with the selected SSB and with a preamble partition applicable to the determined number of PRACH transmissions, one of the multiple ROs at a time instance is determined.

In one embodiment, if at least part of the number of PRACH transmissions are multiplexed in frequency domain, step S720 of determining a group of ROs for indexing may comprise a step of determining a number of ROs that are multiplexed in frequency domain, with the number being equal to the number of simultaneous PRACH transmissions multiplexed in frequency domain.

In one embodiment, the method 700 may further comprise: a step of determining a configured number K of PRACH transmissions; a step of determining a number R of ROs associated with the selected SSB and with a preamble partition applicable to the determined number of PRACH transmissions within one association period; and if the number R is less than the number K, a step of determining an extended association period including a minimum number X of association periods, where a number of ROs associated with the selected SSB and with a preamble partition applicable to the determined number of PRACH transmissions within the X association periods is larger than or equal to the determined configured number K, and wherein step S720 of determining and step S730 of indexing a group of ROs are performed within the extended association period.

In one embodiment, if the number R is larger than or equal to the number K, the number X is determined to be 1, and step S720 of determining and step S730 of indexing a group of ROs are performed within an association period.

In one embodiment, the number K is the determined number of PRACH transmissions, or a largest number of the multiple numbers of PRACH transmissions configured by the network node.

In one embodiment, the method 700 may further comprise: a step of determining a first frame of a first association period of the extended association period as a starting radio frame of the extended association period, and a frame immediately after the end of the extended association period as a starting radio frame of an extended association period next to the extended association period.

In one embodiment, if the number of ROs in the group of ROs within the extended association period is larger than the determined number of PRACH transmissions, step S740 of performing one or more PRACH transmissions based on the determined number of PRACH transmissions in the set of indexed ROs may comprise a step of performing the one or more PRACH transmissions in a first number of ROs in the indexed ROs, the first number being equal to the number of the one or more PRACH transmissions, and a step of repeating a PRACH transmission of the one or more PRACH transmissions in the remaining ROs in the indexed ROs.

In one embodiment, if the number of ROs in the group of ROs within the extended association period is larger than the number of PRACH transmissions, step S740 of performing one or more PRACH transmissions based on the determined number of PRACH transmissions in the set of indexed ROs may comprise a step of performing the one or more PRACH transmissions by distributing the one or more PRACH transmissions over the group of ROs, so that a pattern of used ROs spreading in each of the X association periods is the same.

In one embodiment, step S740 of performing one or more PRACH transmissions based on the determined number of PRACH transmissions in the set of indexed ROs may comprise a step of determining a transmission pattern for the one or more PRACH transmissions, and a step of performing the one or more PRACH transmissions by following the transmission pattern.

In one embodiment, the transmission pattern is identified by frame number.

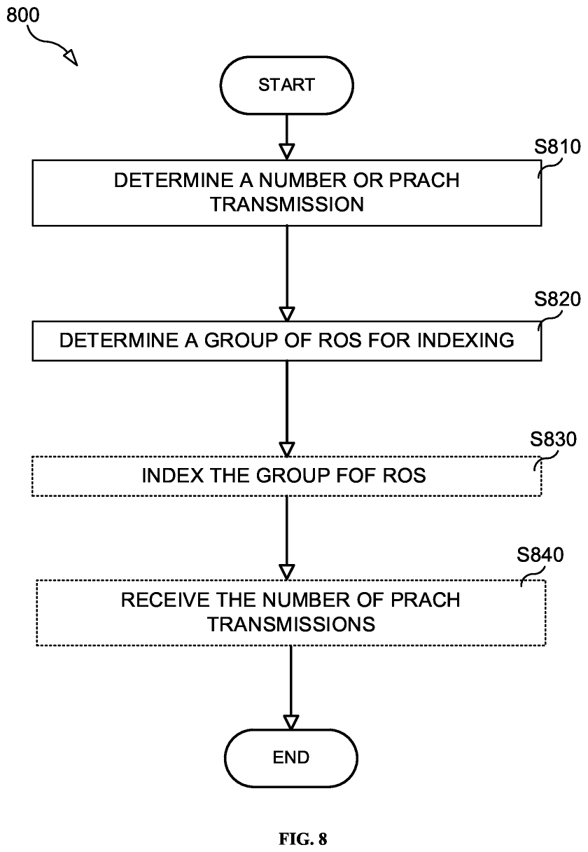

FIG. 8 is a flow chart of an exemplary method 800 at a network node for receiving multiple PRACH transmissions for a PRACH attempt from a terminal node according to an embodiment of the present disclosure. The method 800 may be performed at a network node (e.g., the gNB 105). The method 800 may comprise step S810-S840. However, the present disclosure is not limited thereto. In some other embodiments, the method 800 may comprise more steps, less steps, different steps, or any combination thereof. Further the steps of the method 800 may be performed in a different order than that described herein. Further, in some exemplary embodiments, a step in the method 800 may be split into multiple sub-steps and performed by different entities, and/or multiple steps in the method 800 may be combined into a single step.

The method 800 may begin at step S810 where it determines a number of PRACH transmissions.

At step S820, the network node determines a group of ROs for indexing, where an RO in the group of ROs being associated with a selected SSB and with a preamble partition applicable to the determined number of PRACH transmissions.

Then in step S830, the ROs in the group of ROs determined in step S820 are indexed.

Finally, in step S840, the network node receives and associates the number of PRACH transmissions in a set of indexed ROs, wherein a number of ROs in the set is equal to the determined number of PRACH transmissions. The network node firstly determines a group of ROs, i.e., candidate ROs for receiving the PRACH transmissions, and then selects a set of ROs from the group for actually receiving the PRACH transmissions.

In one embodiment, if the number of PRACH transmissions are multiplexed in time domain, and if there are multiple frequency multiplexing ROs associated with the selected SSB and with a preamble partition applicable to the determined number of PRACH transmissions, one of the multiple ROs at a time instance is determined.

In one embodiment, if at least part of the number of PRACH transmissions are multiplexed in frequency domain, step S820 of determining a group of ROs for indexing may comprise a step of determining a number of ROs that are multiplexed in frequency domain, with the number being equal to the number of simultaneous PRACH transmissions multiplexed in frequency domain.

In one embodiment, the method 800 may further comprise: a step of determining a configured number K of PRACH transmissions; a step of determining a number R of ROs associated with the selected SSB and with a preamble partition applicable to the determined number of PRACH transmissions within one association period; and if the number R is less than the number K, a step of determining an extended association period including a minimum number X of association periods, where a number of ROs associated with the selected SSB and with a preamble partition applicable to the determined number of PRACH transmissions within the X association periods is larger than or equal to the determined configured number K, and wherein step S820 of determining and step S830 of indexing a group of ROs are performed within the extended association period.

In one embodiment, if the number R is larger than or equal to the number K, the number X is determined to be 1, and step S820 of determining and step S830 of indexing a group of ROs are performed within an association period.

In one embodiment, the number K is the determined number of PRACH transmissions, or a largest number of the multiple numbers of PRACH transmissions configured by the network node.

In one embodiment, the method 800 may further comprise: a step of determining a first frame of a first association period of the extended association period as a starting radio frame of the extended association period, and a frame immediately after the end of the extended association period as a starting radio frame of an extended association period next to the extended association period.

In one embodiment, if the number of ROs in the group of ROs within the extended association period is larger than the determined number of PRACH transmissions, step S840 of receiving and associating the number of PRACH transmissions in the set of indexed ROs may comprise a step of receiving the number of PRACH transmissions in a first number of ROs in the indexed ROs, the first number being equal to the number of PRACH transmissions, and a step of receiving a repetition of one of the number of PRACH transmissions in the remaining ROs in the indexed ROs.

In one embodiment, if the number of ROs in the group of ROs within the extended association period is larger than the number of PRACH transmissions, step S840 of receiving and associating the number of PRACH transmissions in the set of indexed ROs may comprise a step of receiving the number of PRACH transmissions that are distributed over the group of ROs, where a pattern of used ROs spreading in each of the X association periods is the same.

In one embodiment, step S840 of receiving the number of PRACH transmissions in the set of indexed ROs may comprise a step of determining a transmission pattern for the number of PRACH transmissions, and a step of receiving the number of PRACH transmissions by following the transmission pattern.

In one embodiment, the transmission pattern is identified by frame number.

Below are some embodiments for RO indexing, so that the UE may determine a set of ROs for a PRACH attempt. It is obvious the present application is not limited thereto.

Embodiment 1, among the ROs associated with one SSB in the X association periods, if there are multiple FDMed ROs associated with one SSB at a time instance, one or more of the following can be used.

For TDMed PRACH transmissions, only one of the FDMed ROs at a time instance is counted for RO indexing and indexed.

For PRACH transmissions where some or all are multiplexed in frequency domain, the number of FDMed ROs counted for RO indexing and indexed is equal to the number of simultaneous PRACH transmissions multiplexed in frequency domain. For example, a UE with two Tx chains may transmit two PRACHs simultaneously in a total of two FDMed ROs. If more than two FDMed ROs are associated with the selected SSB, the UE counts two of them for RO indexing and then indexes them.

Embodiment 2, for a selected SSB and a number of PRACH transmissions K, a UE follows one or more of the following steps to determine X association period and index ROs.
1> determine R, the number of ROs associated with the selected SSB in an association period based on the counting rule in Embodiment 1
   2> if R≥K, X=1.
   2> if R<K, determine X (X>1), the minimum number of association periods so that the number of ROs associated with the selected SSB in the X association periods is no smaller than K
      3> determine the starting radio frame of the X association periods so that mod(starting frame index, X*the number of frames in an association period)=0. In other words, the first X association periods start from frame 0, and the next X association periods start immediately after the end of the previous ones, etc.
1> index the ROs associated with the selected SSB in the X association period(s) based on the indexing rule in Embodiment 1. (Since the X association periods span in time, with FDMed ROs associated with one SSB, the rule in Embodiment 1 is to make sure only the counted ROs are indexed.)

A sub-embodiment of Embodiment 2, provided that a gNB may configure multiple candidate numbers of multiple PRACH transmissions, one or more of the following can be used to determine K, the number of PRACH transmissions, which is used for the determination of X, the number of association periods.
Option 1, K is the same as the determined number of PRACH transmissions
Option 2, K is the largest number of multiple PRACH transmissions configured by gNB

If a gNB configures {2, 4, 8} as the number of PRACH transmissions, a.k.a., PRACH repetition factor, a UE may determine one of them for itself for CBRA or be configured a repetition factor for CFRA. With Option 1, X is UE specific and specific to a PRACH repetition factor. There may be three X values corresponding to the three configured PRACH repetition factors. In contrast Option 2 will result in a cell-specific X, the same to all UEs. The largest RO index with Option 2 may be larger than Option 1, but Option 2 may be simpler for standardization and implementation.

When the determined number of PRACH transmissions is larger than the number of RO groups associated with the selected SSB in an association period, the UE sends a subset of the transmissions in the first association period. The eventual remaining transmissions will be sent in the next association period(s) on the same set of ROs. In one embodiment, If the PRACH transmissions are fewer than the existing ROs in the RO group or association period with the closest capacity to match the transmissions (e.g. 4 transmissions distributed over 3+3 ROs), the number of PRACH transmissions can either be increased to span all ROs in the RO group, or transmit only the determined number, K. In an example the transmissions determined are 4, but the RO group over two association periods has 6 ROs. The UE in this example sends more transmissions than determined to use all ROs in the RO group.

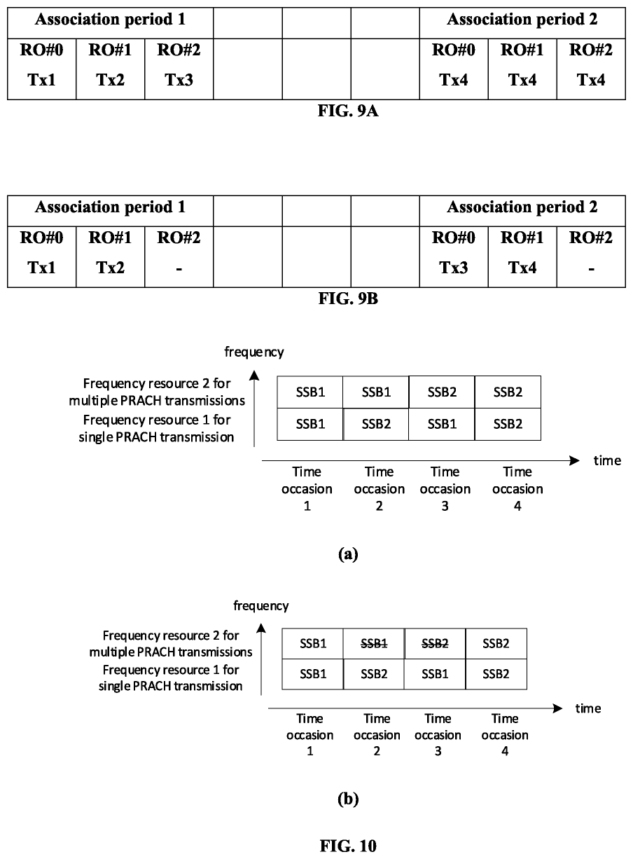

The way of distributing the PRACH transmissions over ROs could be done in a number of ways, e.g.:
Same RO in the X association periods must be used, as shown in FIG. 9A.
Each RO in the X association periods must be used, as shown in FIG. 9B.

In another embodiment, the RO groups allow only for a combination of two multiple transmission patterns, and the pattern is identified by frame number. 8 or 4 transmissions would both be allowed to transmit over two RO groups of 4 ROs, but 4 transmissions would only be allowed on e.g. even frame numbers. This would enable the gNB to know that transmissions on the RO group on odd frame numbers are associated with an equal amount of transmission in the previous or coming association period. It would also increase the chance of detection of at least a subset of the multiple PRACH transmissions. As a sub embodiment, the UE that spans association periods selects even or odd preambles to indicate if the transmission is done as a series of the first half, or the latter half, see below:

| | Odd frame number |
|---|---|
| Even preamble | This is the first part of a |
| | series of transmissions. |
| Odd preamble | This is the last part of a |
| | series of transmissions. |

This would help the gNB to detect the multiple PRACH transmissions since it would know which sets of PRACH transmissions to combine.

### Time-Domain Overlapping ROs Between Two RACH Configurations

Another problem we try to solve is about time-domain overlapping ROs between legacy ROs and separate ROs. This is a legacy problem starting with 2-step RACH in Rel-16. For any feature which requires early UE indication by PRACH, its configured ROs may collide with the legacy ROs for single PRACH transmission or with separate ROs configured for another feature. If the overlapping ROs are associated with different SSBs, gNB in FR2 with analog beamforming is unable to receive PRACH transmissions with different SSB beams.

We take the example of legacy single PRACH transmission and Rel-18 multiple PRACH transmissions. A working assumption made in RAN1 #112 is that separate ROs can be configured by gNB for multiple PRACH transmissions. For example, the separate ROs can be configured with IE of AdditionalRACH-Config-r17. According to 38.331 v17.4.0, ssb-perRACH-OccasionAndCB-PreamblesPerSSB and msg1-FrequencyStart are independently configured for additional ROs.

-- ASN1START
-- TAG-BWP-UPLINKCOMMON-START

| | |
|---|---|
| BWP-Uplink Common ::= | SEQUENCE { |
| genericParameters | BWP, |
| rach-ConfigCommon | SetupRelease { RACH-ConfigCommon } |
| . . . omitted . . . | |
| AdditionalRACH-ConfigList-r17 ::= | SEQUENCE (SIZE(1..maxAdditionalRACH-r17)) |
| OF AdditionalRACH-Config-r17 | |
| AdditionalRACH-Config-r17 ::= | SEQUENCE { |
| rach-ConfigCommon-r17 | RACH-ConfigCommon |
| OPTIONAL, -- Need R | |
| msgA-ConfigCommon-r17 | MsgA-ConfigCommon-r16 |
| OPTIONAL, -- Need R | |
| ... | |
| } | |
| NumberOfMsg3-Repetitions-r17 ::= | ENUMERATED {n1, n2, n3, n4, n7, n8, n12, n16} |

-- TAG-BWP-UPLINKCOMMON-STOP
-- ASN1STOP

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |
| OPTIONAL, -- Need S | |

ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |
| } | OPTIONAL, -- Need M |
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, |
| n100, n200}, | |
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

...,
}
-- TAG-RACH-CONFIGGENERIC-STOP
-- ASN1STOP

An example configuration is illustrated in FIG. 10 (a), where ROs for single PRACH and multiple PRACH transmissions are fully overlapping in time but configured with different frequency resources. We assume two SSBs. The number of N SSBs associated with one RO, provided by ssb-perRACH-OccasionAndCB-PreamblesPerSSB, is one for ROs of single PRACH and onehalf for ROs of multiple PRACH transmissions. (With such configuration, the single PRACH transmission would not occupy too many RACH resources, and for a selected SSB, the two PRACH transmissions of a RACH attempt can occur in consecutive time-domain ROs with a short latency.) As can be seen, in time occasion 2 and time occasion 3, the two FDM ROs are associated with different SSBs. It is not a problem for a gNB capable of receiving in different directions simultaneously. However, gNB with analog beamforming can only receive in one RO with the associated SSB beam at a time, and those transmitted in the FDM RO associated with another SSB are lost. It is likely that a gNB opts to receive RO configured for single PRACH transmission and to give up receiving RO for multiple PRACH transmissions, for the reason that losing one of multiple PRACH transmissions is more tolerable than losing one of a single PRACH. The lost ROs are crossed out in FIG. 10 (b).

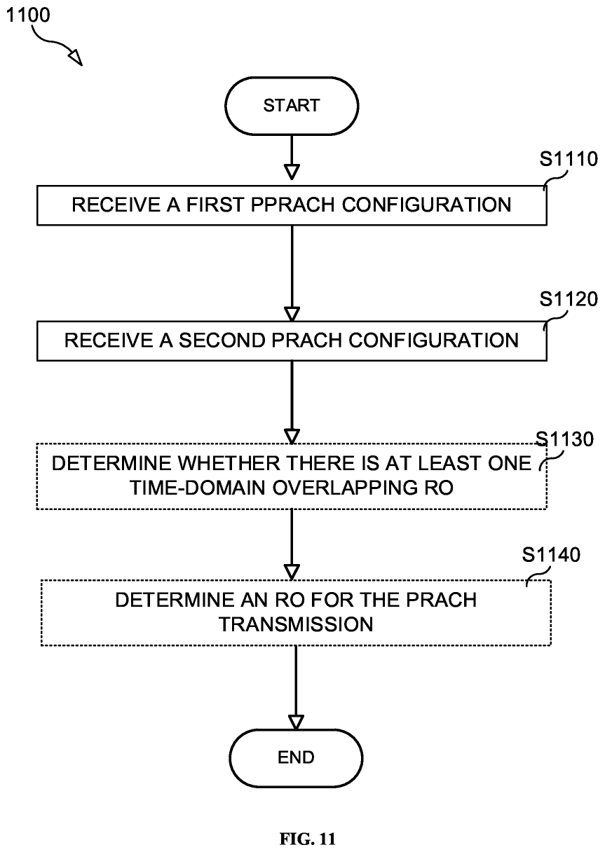

FIG. 11 is a flow chart of an exemplary method 1100 at a terminal node for performing PRACH transmission for a PRACH attempt according to an embodiment of the present disclosure. The method 1100 may be performed at a terminal node (e.g., the UE 100). The method 1100 may comprise step S1110-S1140. However, the present disclosure is not limited thereto. In some other embodiments, the method 1100 may comprise more steps, less steps, different steps, or any combination thereof. Further the steps of the method 1100 may be performed in a different order than that described herein. Further, in some exemplary embodiments, a step in the method 1100 may be split into multiple sub-steps and performed by different entities, and/or multiple steps in the method 1100 may be combined into a single step.

The method 1100 may begin at step S1110 where a first PRACH configuration is received from a network node. The first PRACH configuration configures a first set of ROs and comprises a first SSB mapping indication indicating the mapping of SSBs to ROs.

At step S1120, the terminal node receives a second PRACH configuration from the network node. The second PRACH configuration configures a second set of ROs and comprises a second SSB mapping indication indicating the mapping of SSBs to ROs.

Then in step S1130, the network node determines whether there is at least one RO associated with one SSB according to the first PRACH configuration overlapping in time domain with an RO associated with a different SSB according to the second PRACH configuration.

Finally, in step S1140, in response to determining there is at least one RO associated with one SSB according to the first PRACH configuration overlapping in time domain with an RO associated with a different SSB according to the second PRACH configuration, the network node determines an RO for the PRACH transmission.

In one embodiment, step S1140 of determining an RO for the PRACH transmission may comprise a step of determining whether the network node is capable of receiving PRACH transmissions with different SSB beams simultaneously.

In one embodiment, if the time-overlapping ROs are configured with different priorities, it is determined that the network node is not capable of receiving PRACH transmissions with different SSB beams simultaneously and in this case the network node only receives PRACH transmissions in RO of high priority.

In one embodiment, if an RO of a RACH configuration in which the terminal node selects for PRACH transmission is of a lower priority, step S1140 of determining an RO for the PRACH transmission may comprise a step of determining the RO for the PRACH transmission.

In one embodiment, the step of determining the RO for the PRACH transmission may comprise a step of determining ROs mapped to SSBs based on the received first and second PRACH configurations, where the time-overlapping ROs with a lower priority are not associated with an SSB, which is different from an SSB, which the time-overlapping ROs with a high priority is associated with.

In one embodiment, the step of determining the RO for the PRACH transmission may comprise a step of not counting the time-overlapping ROs of a lower priority in determining the RO.

Below are some embodiments for RO selecting in case there are time-domain overlapping ROs between two RACH configurations, so that the UE may determine an RO for a PRACH attempt. It is obvious the present application is not limited thereto.

The time-domain overlapping ROs between two RACH configurations may be configured with different frequency resources or the same frequency resource.

Embodiment 1, a gNB can indicate whether it is capable of receiving with different SSB beams simultaneously or not by configuration.

A sub-embodiment, a gNB can configure a priority for ROs in a RACH configuration. If time-overlapping ROs are associated with different SSBs and configured with different priorities, it implies that the gNB is incapable of simultaneously receiving ROs associated with different SSBs, and the RO with lower priority is to be lost. Absence of the priority configuration or the same priority configured for the time-domain overlapping ROs indicates that gNB has no problem of simultaneously receiving the ROs with different SSB beams.

A UE usually does the following two steps before PRACH transmission, based on which we provide some options:
1) associate ROs with SSB indexes (SSB indexes to RO mapping) according to ssb-perRACH-OccasionAndCB-PreamblesPerSSB
2) for the selected SSB, determine RO(s) for PRACH transmission(s)

Embodiment 2, if time-domain overlapping ROs are associated with different SSBs, and a UE, which plans to transmit PRACH in a low-priority RO, knows that a gNB is incapable of simultaneously receiving the RO in which it will transmit, one or more of the following can be taken to prevent the gNB from losing an RO.
Option 1, the UE can redo the SSB indexes to RO mapping for the low priority ROs. It would not associate an RO of low priority with a different SSB index than that of the high-priority time-overlapping RO. In other words, some ROs of low priority are not associated with an SSB index, unless the SSB index is the same as the one for the time-domain overlapping high-priority ROs.
Option 2, the time-domain overlapping RO with low priority is not counted for the determination of a set of ROs for multiple PRACH transmissions, namely the UE can look for another RO to make up the uncounted RO.
Option 3, the UE doesn't transmit in the time-domain overlapping RO with a low priority.

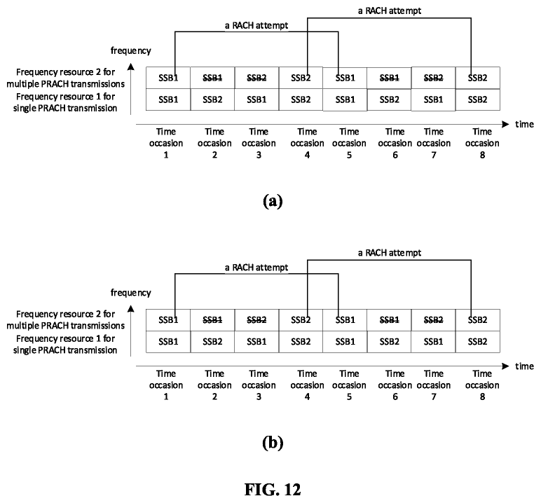

The result of applying the options is illustrated in FIG. 12 (a) and FIG. 12(b). in particular, FIG. 12(a) shows the result of applying Option 1, and FIG. 12(b) shows the result of applying Option 2. Assume ROs for multiple PRACH transmissions are of lower priority. With Option 1, after a UE realizes the different SSB indexes in time occasion 2, it will redo the SSB-RO mapping for the low priority ROs configured for multiple PRACH transmissions. With ssb-perRACH-OccasionAndCB-PreamblesPerSSB configured as onehalf, every SSB are associated with two ROs. To map ROs in frequency resource 2, the UE skips the RO in time occasion 2 and associates the RO in time occasion 3 with SSB1, which is the same SSB index for the time-overlapping RO in frequency resource 1. After mapping one RO for SSB2 in time occasion 4, the next one is in time occasion 6 and the one in time occasion 5 is not associated with an SSB. With Option 2, since the UE knows PRACH transmission with frequency resource 2 and in time occasion 2, 3, 6 and 7 are not to be received by gNB, it selects the ROs which can be received by gNB for its transmission. For an example of two PRACH transmissions of a RACH attempt, two non-consecutive ROs associated with an SSB form a set of ROs for a RACH attempt.

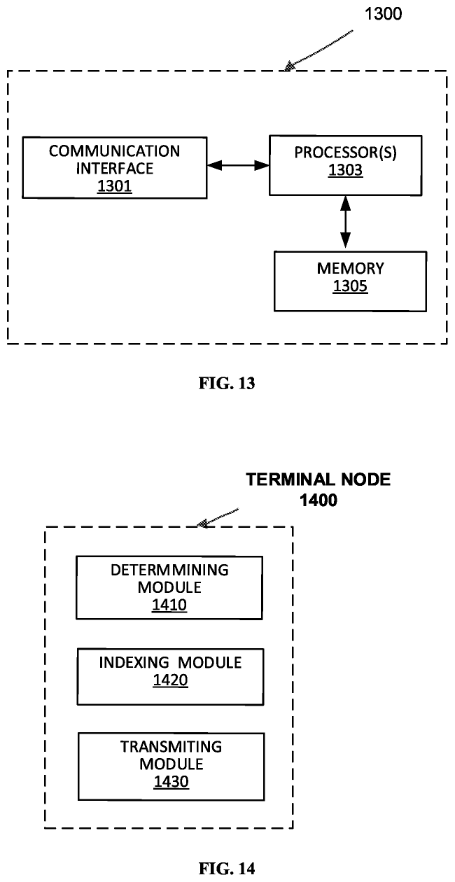

FIG. 13 schematically shows an embodiment of an arrangement 1300 which may be used in a terminal node (e.g., the UE 100) or a network node (e.g., the gNB 105) according to an embodiment of the present disclosure.

Comprised in the arrangement 1300 are a controlling unit or processing unit 1303, e.g., with a Digital Signal Processor (DSP) or a Central Processing Unit (CPU). The processing unit 1303 may be a single unit or a plurality of units to perform different actions of procedures described herein by executing a computer program. The computer program may be stored in a memory 1305. The memory 1305 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory.

The arrangement 1300 may also comprise a communication interface 1301 arranged for communication. The communication interface 1301 may be implemented as an input unit for receiving signals from other entities, and an output unit for providing signal(s) to other entities. The communication interface 401 may also be implemented as an integrated entity or as separate entities.

The computer program, which comprises code/computer readable instructions, which when executed by the processing unit 1303 in the arrangement 400 causes the arrangement 1300 and/or the terminal node/network node in which it is comprised to perform the actions, e.g., of the procedure described earlier in conjunction with FIG. 7, FIG. 8 and FIG. 11 or any other variant.

The computer program may be configured as a computer program code structured in computer program modules. Hence, in an exemplifying embodiment when the arrangement 1300 is used in a terminal node, the code in the computer program of the arrangement 1300 includes: a module configured to determine a number of PRACH transmissions based on a parameter received from a network node; a module configured to determine a group of ROs for indexing, where an RO in the group of ROs being associated with a selected SSB and with a preamble partition applicable to the determined number of PRACH transmissions; a module configured to index the determined ROs in the group of ROs; and a module configured to perform one or more PRACH transmissions based on the determined number of PRACH transmissions in a set of indexed ROs, wherein a number of ROs in the set is equal to the determined number of PRACH transmissions.

Additionally or alternatively, in an exemplifying embodiment when the arrangement 1300 is used in a network node, the code in the computer program of the arrangement 1300 includes: a module configured to determine a number of PRACH transmissions; a module configured to determine a group of ROs for indexing, where an RO in the group of ROs being associated with a selected SSB and with a preamble partition applicable to the determined number of PRACH transmissions; a module configured to index the determined ROs in the group of ROs; and a module configured to receive and associate the number of PRACH transmissions in a set of indexed ROs, wherein a number of ROs in the set is equal to the determined number of PRACH transmissions.

Additionally or alternatively, in an exemplifying embodiment when the arrangement 1300 is used in a terminal node, the code in the computer program of the arrangement 1300 includes: a module configured to receive a first PRACH configuration from a network node, where the first PRACH configuration configures a first set of ROs and comprises a first SSB mapping indication indicating the mapping of SSBs to ROs; a module configured to receive a second PRACH configuration from a network node, where the first PRACH configuration configures a second set of ROs and comprises a second SSB mapping indication indicating the mapping of SSBs to ROs; a module configured to determine whether there is at least one RO associated with one SSB according to the first PRACH configuration overlapping in time domain with an RO associated with a different SSB according to the second PRACH configuration; and a module configured to, in response to determining there is at least one RO associated with one SSB according to the first PRACH configuration overlapping in time domain with an RO associated with a different SSB according to the second PRACH configuration, determine an RO for the PRACH transmission.

The computer program modules could essentially perform the actions of the flow illustrated in FIG. 7, FIG. 8 and FIG. 11, to emulate the terminal node or the network node. In other words, when the different computer program modules are executed in the processing unit 1103, they may correspond to different modules in the terminal node or the network node.

Although the code means in the embodiments disclosed above in conjunction with FIG. 13 are implemented as computer program modules which when executed in the processing unit causes the arrangement to perform the actions described above in conjunction with the figures mentioned above, at least one of the code means may in alternative embodiments be implemented at least partly as hardware circuits.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1303 causes the arrangement 1300 to perform the actions, e.g., of the procedure described earlier in conjunction with FIG. 7; or code/computer readable instructions, which when executed by the processor 1303 causes the arrangement 1300 to perform the actions, e.g., of the procedure described earlier in conjunction with FIG. 8; or code/computer readable instructions, which when executed by the processor 1303 causes the arrangement 1300 to perform the actions, e.g., of the procedure described earlier in conjunction with FIG. 11.

The computer program product may be configured as a computer program code structured in computer program modules. The computer program modules could essentially perform the actions of the flow illustrated in FIG. 7, FIG. 8 or FIG. 11.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the terminal node and/or the network node.

Correspondingly to the method 700 as described above, an exemplary terminal node is provided. FIG. 14 is a block diagram of a terminal node 1400 according to an embodiment of the present disclosure. The terminal node 1400 may be, e.g., the UE 100 in some embodiments.

The terminal node 1400 may be configured to perform the method 700 as described above in connection with FIG. 7. As shown in FIG. 14, the terminal node 1400 may comprise a receiving module 1410 configured to determine a number of PRACH transmissions based on a parameter received from a network node, and determine a group of ROs for indexing, where an RO in the group of ROs being associated with a selected SSB and with a preamble partition applicable to the determined number of PRACH transmissions; an indexing module 1420 configured to index the determined ROs in the group of ROs; and a transmitting module 1430 configured to perform one or more PRACH transmissions based on the determined number of PRACH transmissions in a set of indexed ROs, wherein a number of ROs in the set is equal to the determined number of PRACH transmissions.

The above modules 1410, 1420 and/or 1430 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7. Further, the terminal node 1400 may comprise one or more further modules, each of which may perform any of the steps of the method 700 described with reference to FIG. 7.

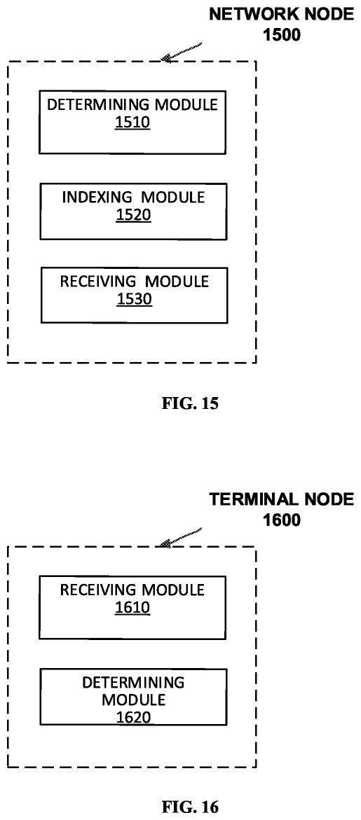

Correspondingly to the method 800 as described above, a network node is provided. FIG. 15 is a block diagram of an exemplary network node 1500 according to an embodiment of the present disclosure. The network node 1500 may be, e.g., the gNB 105 in some embodiments.

The network node 1500 may be configured to perform the method 800 as described above in connection with FIG. 8. As shown in FIG. 15, the network node 1500 may comprise a determining module 1510 configured to determine a number of PRACH transmissions, and to determine a group of ROs for indexing, where an RO in the group of ROs being associated with a selected SSB and with a preamble partition applicable to the determined number of PRACH transmissions; an indexing module 1520 configured to index the determined ROs in the group of ROs; and a receiving module 1530 configured to receive and associate the number of PRACH transmissions in a set of indexed ROs, wherein a number of ROs in the set is equal to the determined number of PRACH transmissions.

The above modules 1510, 1520 and/or 15300 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 8. Further, the network node 1500 may comprise one or more further modules, each of which may perform any of the steps of the method 900 described with reference to FIG. 8.

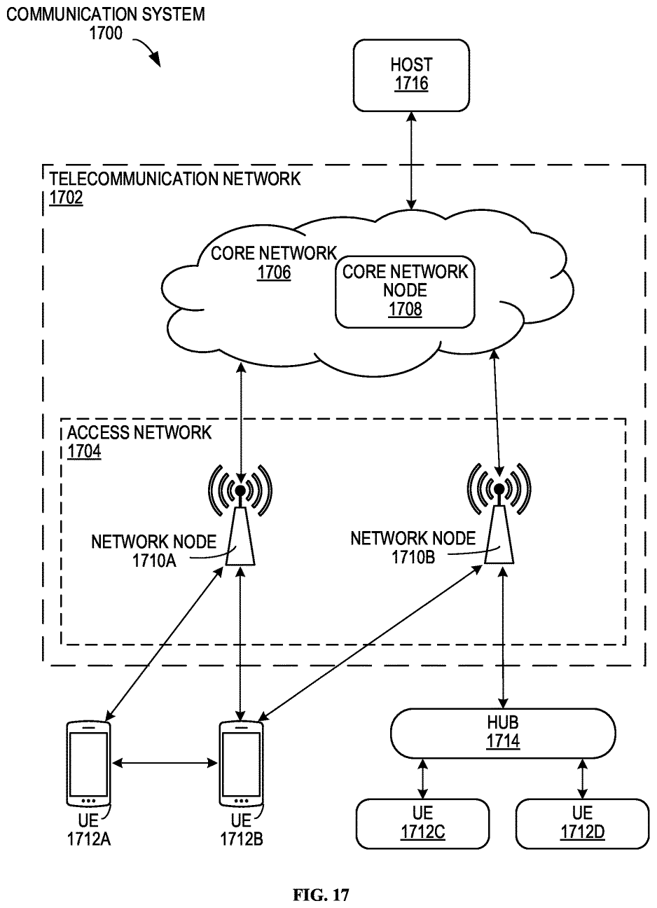

Correspondingly to the method 1100 as described above, an exemplary terminal node is provided. FIG. 16 is a block diagram of a terminal node 1600 according to an embodiment of the present disclosure. The terminal node 1600 may be, e.g., the UE 100 in some embodiments.

The terminal node 1600 may be configured to perform the method 1100 as described above in connection with FIG. 11. As shown in FIG. 16, the terminal node 1600 may comprise a receiving module 1610 configured to receive a first PRACH configuration from a network node, where the first PRACH configuration configures a first set of ROs and comprises a first SSB mapping indication indicating the mapping of SSBs to ROs, and to receive a second PRACH configuration from a network node, where the first PRACH configuration configures a second set of ROs and comprises a second SSB mapping indication indicating the mapping of SSBs to ROs; a determining module 1620 configured to determine whether there is at least one RO associated with one SSB according to the first PRACH configuration overlapping in time domain with an RO associated with a different SSB according to the second PRACH configuration, and in response to determining there is at least one RO associated with one SSB according to the first PRACH configuration overlapping in time domain with an RO associated with a different SSB according to the second PRACH configuration, determine an RO for the PRACH transmission.

The above modules 1610 and/or 1620 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 11. Further, the terminal node 1600 may comprise one or more further modules, each of which may perform any of the steps of the method 1100 described with reference to FIG. 11.

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3^{rd} Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

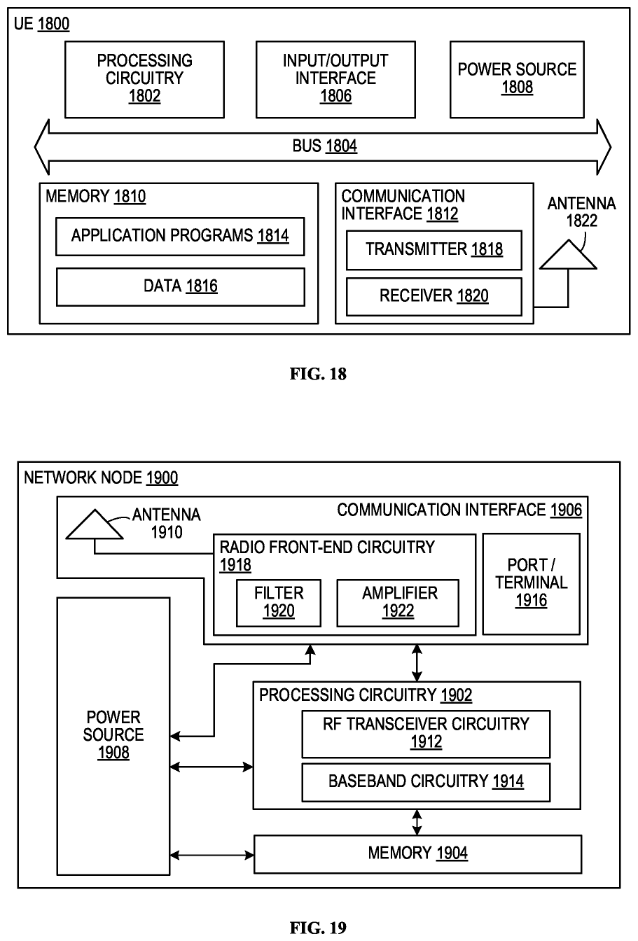

As a whole, the communication system 1700 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

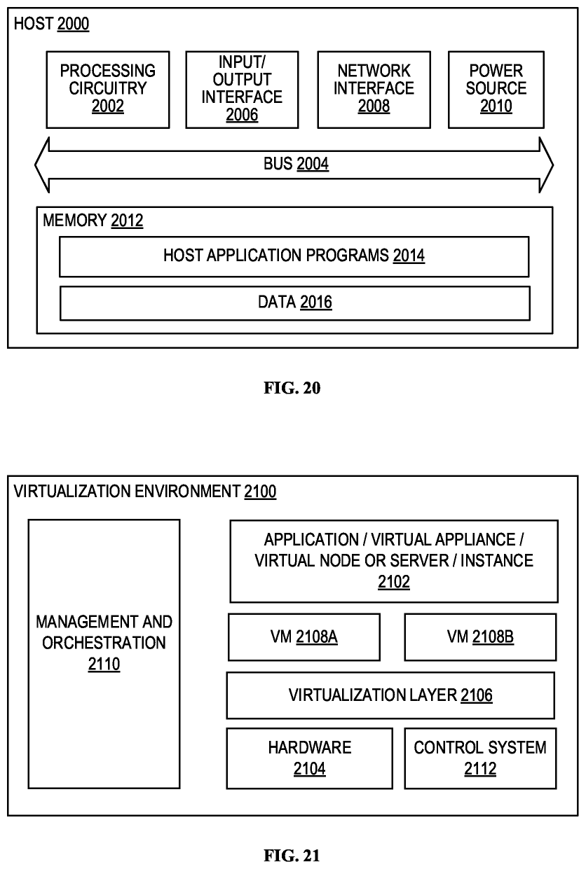

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

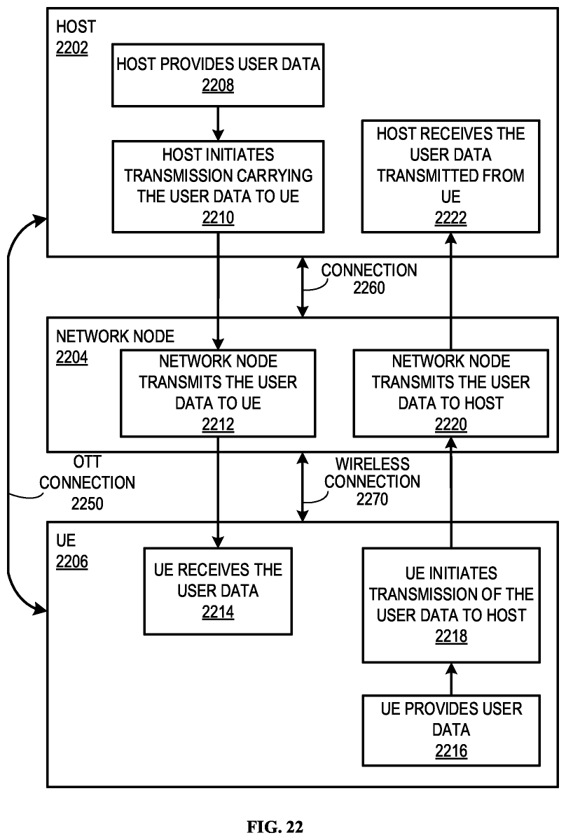

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment. More precisely, the teachings of these embodiments may improve the success possibility of random access, and thereby provide benefits such as reduced user waiting time.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

### Numbered Embodiments

1. A method (700) at a terminal node for performing multiple Physical Random Access Channel, PRACH, transmissions for a PRACH attempt, comprising:
determining (S710) a number of PRACH transmissions based on a parameter received from a network node,
determining (S720) a group of PRACH Occasions, ROs, for indexing, where an RO in the group of ROs being associated with a selected SSB and with a preamble partition applicable to the determined number of PRACH transmissions,
indexing (S730) the determined ROs in the group of ROs, and
performing (S740) one or more PRACH transmissions based on the determined number of PRACH transmissions in a set of indexed ROs, wherein a number of ROs in the set is equal to the determined number of PRACH transmissions.

2. The method of embodiment 1, wherein if the number of PRACH transmissions are multiplexed in time domain, and if there are multiple frequency multiplexing ROs associated with the selected SSB and with a preamble partition applicable to the determined number of PRACH transmissions, one of the multiple ROs at a time instance is determined.

3. The method of embodiment 1 or 2, wherein if at least part of the number of PRACH transmissions are multiplexed in frequency domain, determining a group of ROs for indexing comprises:
determining a number of ROs that are multiplexed in frequency domain, with the number being equal to the number of simultaneous PRACH transmissions multiplexed in frequency domain.

4. The method of any of embodiments 1 to 3, further comprising:
determining a configured number K of PRACH transmissions,
determining a number R of ROs associated with the selected SSB and with a preamble partition applicable to the determined number of PRACH transmissions within one association period, and
if the number R is less than the number K, determining an extended association period including a minimum number X of association periods, where a number of ROs associated with the selected SSB and with a preamble partition applicable to the determined number of PRACH transmissions within the X association periods is larger than or equal to the determined configured number K, and
wherein determining and indexing a group of ROs are performed within the extended association period.

5. The method of embodiment 4, wherein if the number R is larger than or equal to the number K, the number X is determined to be 1, and determining and indexing a group of ROs are performed within an association period.

6. The method of embodiment 4 or 5, wherein the number K is the determined number of PRACH transmissions, or a largest number of the multiple numbers of PRACH transmissions configured by the network node.

7. The method of any of embodiments 4 to 6, further comprising:
determining a first frame of a first association period of the extended association period as a starting radio frame of the extended association period, and a frame immediately after the end of the extended association period as a starting radio frame of an extended association period next to the extended association period.

8. The method of any of embodiments 4 to 7, wherein if the number of ROs in the group of ROs within the extended association period is larger than the determined number of PRACH transmissions, performing one or more PRACH transmissions based on the determined number of PRACH transmissions in the set of indexed ROs comprises:
performing the one or more RACH transmissions in a first number of ROs in the indexed ROs, the first number being equal to the number of PRACH transmissions, and repeating a PRACH transmission of the one or more PRACH transmissions in the remaining ROs in the indexed ROs.

9. The method of any of embodiments 4 to 7, wherein if the number of ROs in the group of ROs within the extended association period is larger than the number of PRACH transmissions, performing one or more PRACH transmissions based on the determined number of PRACH transmissions in the set of indexed ROs comprises:
performing the one or more PRACH transmissions by distributing the one or more PRACH transmissions over the group of ROs, so that a pattern of used ROs spreading in each of the X association periods is the same.

10. The method of any of embodiments 1 to 9, wherein performing one or more PRACH transmissions based on the determined number of PRACH transmissions in the set of indexed ROs comprises:
determining a transmission pattern for the one or more PRACH transmissions, and
performing the one or more PRACH transmissions by following the transmission pattern.

11. The method of embodiment 10, wherein the transmission pattern is identified by frame number.

12. A method (800) at a network node for receiving multiple Physical Random Access Channel, PRACH, transmissions for a PRACH attempt from a terminal node, comprising:
determining (S810) a number of PRACH transmissions,
determining (S820) a group of PRACH Occasions, ROs, for indexing, where an RO in the group of ROs being associated with a selected SSB and with a preamble partition applicable to the determined number of PRACH transmissions,
indexing (S830) the determined ROs in the group of ROs, and
receiving and associating (S840) the number of PRACH transmissions in a set of indexed ROs with a PRACH attempt, wherein a number of ROs in the set is equal to the determined number of PRACH transmissions.

13. The method of embodiment 12 wherein if the number of PRACH transmissions are multiplexed in time domain, and if there are multiple frequency multiplexing ROs associated with the selected SSB and with a preamble partition applicable to the determined number of RRACH transmission, one of the multiple ROs at a time instance is determined.

14. The method of embodiment 12 or 13, wherein if at least part of the number of PRACH transmissions are multiplexed in frequency domain, determining a group of ROs for indexing comprises:
determining a number of ROs that are multiplexed in frequency domain, with the number being equal to the number of simultaneous PRACH transmissions multiplexed in frequency domain.

15. The method of any of embodiments 12 to 14, further comprising:
determining a configured number K of PRACH transmissions,
determining a number R of ROs associated with the selected SSB and with a preamble partition applicable to the determined number of PRACH transmissions within one association period, and
if the number R is less than the number K, determining an extended association period including a minimum number X of association periods, where a number of ROs associated with the selected SSB and with a preamble partition applicable to the determined number of PRACH transmissions within the X association periods is larger than or equal to the determined configured number K, and
wherein determining and indexing a group of ROs are performed within the extended association period.

16. The method of embodiment 15, wherein if the number R is larger than or equal to the number K, the number X is determined to be 1, and determining and indexing a group of ROs are performed within an association period.

17. The method of embodiment 15 or 16, wherein the number K is the determined number of PRACH transmissions, or a largest number of the multiple numbers of PRACH transmissions configured by the network node.

18. The method of any of embodiments 15 to 17, further comprising:
determining a first frame of a first association period of the extended association period as a starting radio frame of the extended association period, and a frame immediately after the end of the extended association period as a starting radio frame of an extended association period next to the extended association period.

19. The method of any of embodiments 15 to 18, wherein if the number of ROs in the group of ROs within the extended association period is larger than the determined number of PRACH transmissions, receiving and associating the number of PRACH transmissions in the set of indexed ROs comprises:
receiving the number of PRACH transmissions in a first number of ROs in the indexed ROs, the first number being equal to the number of PRACH transmissions, and
receiving a repetition of one of the number of PRACH transmissions in the remaining ROs in the indexed ROs.

20. The method of any of embodiments 15 to 18, wherein if the number of ROs in the group of ROs within the extended association period is larger than the number of PRACH transmissions, receiving and associating the number of PRACH transmissions in the set of indexed ROs comprises:
receiving the number of PRACH transmissions that are distributed over the group of ROs, wherein a pattern of used ROs spreading in each of the X association periods is the same.

21. The method of any of embodiments 12 to 20, wherein receiving the number of PRACH transmissions in the set of indexed ROs comprises:
determining a transmission pattern for the number of PRACH transmissions, and receiving the number of PRACH transmissions by following the transmission pattern.

22. The method of embodiment 21, wherein the transmission pattern is identified by frame number.

23. A method (1100) at a terminal node for performing PRACH transmission for a PRACH attempt, comprising:
receiving (S1110) a first Physical Random Access Channel (PRACH) configuration from a network node, wherein the PRACH configuration configures a first set of ROs and comprises a first SSB mapping indication indicating the mapping of Synchronization Signal/Physical Broadcast Channels, SSBs to PRACH Occasions, ROs,
receiving (S1120) a second PRACH configuration from a network node, wherein the second PRACH configuration configures a second set of ROs and comprises a second SSB mapping indication indicating the mapping of SSBs to ROs,
determining (S1130) whether there is at least one RO associated with one SSB according to the first PRACH configuration overlapping in time domain with an RO associated with a different SSB according to the second PRACH configuration, and
in response to determining there is at least one RO associated with one SSB according to the first PRACH configuration overlapping in time domain with an RO associated with a different SSB according to the second PRACH configuration, determining (S1130) an RO for the PRACH transmission.

24. The method of embodiment 23, wherein determining an RO for the PRACH transmission comprises:
determining whether the network node is capable of receiving PRACH transmissions with different SSB beams simultaneously.

25. The method of embodiment 24, wherein if the time-overlapping ROs are configured with different priorities, it is determined that the network node is not capable of receiving PRACH transmissions with different SSB beams simultaneously and in this case the network node only receives PRACH transmissions in RO of high priority.

26. The method of embodiment 25, wherein if an RO of a RACH configuration in which the terminal node selects for PRACH transmission is of a lower priority, determining an RO for the PRACH transmission comprises:
determining the RO for the PRACH transmission.

27. The method of embodiment 26, wherein determining the RO for the PRACH transmission comprises:
determining ROs mapped to SSBs based on the received first and second PRACH configurations, where the time-overlapping ROs with a lower priority are not associated with an SSB, which is different from an SSB, which the time-overlapping ROs with a high priority is associated with.

28. The method of embodiment 26, wherein determining the RO for the PRACH transmission comprises:
not counting the time-overlapping ROs of a lower priority in determining the RO.

29. A terminal node (1300), comprising:
a communication interface (1301) arranged for communication,
at least one processor (1303), and
a memory (1305) comprising instructions which, when executed by the at least one processor, cause the terminal node to perform the method of any of embodiments 1 to 11.

30. A network node (1300), comprising:
a communication interface (1301) arranged for communication,
at least one processor (1303), and
a memory (1305) comprising instructions which, when executed by the at least one processor, cause the network node to perform the method of any of embodiments 12 to 22 and embodiments 23-28.

31. A computer program comprising instructions which, when executed by at least one processor, cause the at least one processor to carry out the method of any of embodiments 1 to 11.

32. A computer program comprising instructions which, when executed by at least one processor, cause the at least one processor to carry out the method of any of embodiments 12 to 22 and embodiments 23-28.

33. A carrier containing the computer program of embodiments 31 or 32, wherein the carrier is one of an electronic signal, optical signal, radio signal, or computer readable storage medium.

1.-18. (canceled)

19. A method at a terminal node for performing multiple Physical Random Access Channel (PRACH) transmissions for a PRACH attempt, the method comprising:
determining a number of PRACH transmissions based on a parameter received from a network node,
determining a configured number K of PRACH transmissions,
determining a number R of PRACH Occasions (ROs) associated with a selected synchronization signal (SS) and physical broadcast channel (PBCH) block (SSB) and with a preamble partition applicable to the determined number of PRACH transmissions within one association period,
determining an extended association period, the extended association period including a number X of association periods, where the number X of association periods is the minimum number of association periods such that X·R≥K,
determining, within the extended association period, a set of ROs for indexing, where an RO in the set of ROs is associated with the selected SSB and with a preamble partition applicable to the determined number of PRACH transmissions,
indexing the determined ROs in the set of ROs, and
performing one or more PRACH transmissions based on the determined number of PRACH transmissions in the set of indexed ROs, wherein the number of ROs in the set is equal to the determined number of PRACH transmissions.

20. The method of claim 19, wherein, if the number X is determined to be 1, determining and indexing the set of ROs are performed within an association period.

21. The method of claim 19, wherein the number K is a largest one of multiple candidate number of PRACH transmissions configured by the network node.

22. The method of claim 19, further comprising:
determining a first frame of a first association period of the extended association period as a starting radio frame of the extended association period, and a frame immediately after the end of the extended association period as a starting radio frame of an extended association period next to the extended association period.

23. The method of claim 19, wherein, if the number of ROs in the set of ROs within the extended association period is larger than the determined number of PRACH transmissions, performing one or more PRACH transmissions based on the determined number of PRACH transmissions in the set of indexed ROs comprises:
performing the one or more PRACH transmissions in a first number of ROs in the indexed ROs, the first number being equal to the number of PRACH transmissions, and
repeating a PRACH transmission of the one or more PRACH transmissions in the remaining ROs in the indexed ROs.

24. The method of claim 19, wherein performing one or more PRACH transmissions based on the determined number of PRACH transmissions in the set of indexed ROs comprises:
determining a transmission pattern for the one or more PRACH transmissions, and
performing the one or more PRACH transmissions by following the transmission pattern.

25. The method of claim 24, wherein the transmission pattern is identified by frame number.

26. A method at a network node for receiving multiple Physical Random Access Channel (PRACH) transmissions for a PRACH attempt from a terminal node, the method comprising:
determining a number of PRACH transmissions,
determining a configured number K of PRACH transmissions,
determining a number R of PRACH Occasions (ROs) associated with a selected synchronization signal (SS) and physical broadcast channel (PBCH) block (SSB) and with a preamble partition applicable to the determined number of PRACH transmissions within one association period,
determining an extended association period, the extended association period including a number X of association periods, where the number X of association periods is the minimum number of association periods such that X·R≥K,
determining, within the extended association period, a set of ROs for indexing, where an RO in the set of ROs is associated with the selected SSB and with a preamble partition applicable to the determined number of PRACH transmissions,
indexing the determined ROs in the set of ROs, and
receiving and associating the number of PRACH transmissions in the set of indexed ROs with a PRACH attempt, wherein the number of ROs in the set is equal to the determined number of PRACH transmissions.

27. The method of claim 26, wherein, if number X is determined to be 1, determining and indexing the set of ROs are performed within an association period.

28. The method of claim 26, wherein the number K is a largest one of multiple candidate number of PRACH transmissions configured by the network node.

29. The method of claim 26, further comprising:
determining a first frame of a first association period of the extended association period as a starting radio frame of the extended association period, and a frame immediately after the end of the extended association period as a starting radio frame of an extended association period next to the extended association period.

30. The method of claim 26, wherein, if the number of ROs in the set of ROs within the extended association period is larger than the determined number of PRACH transmissions, receiving and associating the number of PRACH transmissions in the set of indexed ROs comprises:
receiving the number of PRACH transmissions in a first number of ROs in the indexed ROs, the first number being equal to the number of PRACH transmissions, and
receiving a repetition of one of the number of PRACH transmissions in the remaining ROs in the indexed ROs.

31. The method of claim 26, wherein receiving the number of PRACH transmissions in the set of indexed ROs comprises:
determining a transmission pattern for the number of PRACH transmissions, and
receiving the number of PRACH transmissions by following the transmission pattern.

32. A terminal node, for performing multiple Physical Random Access Channel (PRACH) transmissions for a PRACH attempt, the terminal node comprising:
processing circuitry configured to:
determine a number of PRACH transmissions based on a parameter received from a network node,
determine a configured number K of PRACH transmissions,
determine a number R of PRACH Occasions (ROs) associated with a selected synchronization signal (SS) and physical broadcast channel (PBCH) block (SSB) and with a preamble partition applicable to the determined number of PRACH transmissions within one association period,
determine an extended association period, the extended association period including a number X of association periods, where the number X of association periods is the minimum number of association periods such that X·R≥K,
determine, within the extended association period, a set of ROs for indexing, where an RO in the set of ROs is associated with the selected SSB and with a preamble partition applicable to the determined number of PRACH transmissions,
index the determined ROs in the set of ROs, and
perform one or more PRACH transmissions based on the determined number of PRACH transmissions in the set of indexed ROs, wherein the number of ROs in the set is equal to the determined number of PRACH transmissions.

33. The terminal node of claim 32, wherein the processing circuitry is configured to, if the number X is determined to be 1, determine and index the set of ROs within an association period.

34. The terminal node of claim 32, wherein the number K is a largest one of multiple candidate number of PRACH transmissions configured by the network node.

35. The terminal node of claim 32, wherein the processing circuitry is further configured to:
determine a first frame of a first association period of the extended association period as a starting radio frame of the extended association period, and a frame immediately after the end of the extended association period as a starting radio frame of an extended association period next to the extended association period.

36. The terminal node of claim 32, wherein the processing circuitry is configured to, if the number of ROs in the set of ROs within the extended association period is larger than the determined number of PRACH transmissions, perform one or more PRACH transmissions based on the determined number of PRACH transmissions in the set of indexed ROs by:
performing the one or more PRACH transmissions in a first number of ROs in the indexed ROs, the first number being equal to the number of PRACH transmissions, and
repeating a PRACH transmission of the one or more PRACH transmissions in the remaining ROs in the indexed ROs.

37. The terminal node of claim 32, wherein the processing circuitry is configured to perform one or more PRACH transmissions based on the determined number of PRACH transmissions in the set of indexed ROs by:
determining a transmission pattern for the one or more PRACH transmissions, and
performing the one or more PRACH transmissions by following the transmission pattern.

38. The terminal node of claim 37, wherein the transmission pattern is identified by frame number.

39. A network node for receiving multiple Physical Random Access Channel (PRACH) transmissions for a PRACH attempt from a terminal node, the network node comprising:
processing circuitry configured to:
determine a number of PRACH transmissions,
determine a configured number K of PRACH transmissions,
determine a number R of PRACH Occasions (ROs) associated with a selected synchronization signal (SS) and physical broadcast channel (PBCH) block (SSB) and with a preamble partition applicable to the determined number of PRACH transmissions within one association period,
determine an extended association period, the extended association period including a number X of association periods, where the number X of association periods is the minimum number of association periods such that X·R≥K,
determine, within the extended association period, a set of ROs for indexing, where an RO in the set of ROs is associated with the selected SSB and with a preamble partition applicable to the determined number of PRACH transmissions,
index the determined ROs in the set of ROs, and
receive and associate the number of PRACH transmissions in the set of indexed ROs with a PRACH attempt, wherein the number of ROs in the set is equal to the determined number of PRACH transmissions.

40. The network node of claim 39, wherein the processing circuitry is configured to, if number X is determined to be 1, determine and index the set of ROs within an association period.

41. The network node of claim 39, wherein the number K is a largest one of multiple candidate number of PRACH transmissions configured by the network node.

42. The network node of claim 39, wherein the processing circuitry is further configured to:
determine a first frame of a first association period of the extended association period as a starting radio frame of the extended association period, and a frame immediately after the end of the extended association period as a starting radio frame of an extended association period next to the extended association period.

43. The network node of claim 39, wherein the processing circuitry is configured to, if the number of ROs in the set of ROs within the extended association period is larger than the determined number of PRACH transmissions, receive and associate the number of PRACH transmissions in the set of indexed ROs by:
receiving the number of PRACH transmissions in a first number of ROs in the indexed ROs, the first number being equal to the number of PRACH transmissions, and
receiving a repetition of one of the number of PRACH transmissions in the remaining ROs in the indexed ROs.

44. The network node of claim 39, wherein the processing circuitry is configured to receive the number of PRACH transmissions in the set of indexed ROs by:
determining a transmission pattern for the number of PRACH transmissions, and
receiving the number of PRACH transmissions by following the transmission pattern.
